(19) United States
(12) Patent Application Publication
(10) Pub. No.: US 2026/0266740 A1
(43) Pub. Date: Sep. 10, 2026

(54) Radiation Generator, Inspection Device, and Radiation Generation Method

(71) Applicant: BRIGHTEST TECHNOLOGY TAIWAN CO., LTD., Hsinchu County (TW)

(72) Inventors: Pei-Chi Huang, Hsinchu County (TW); Shih-Cheng Liu, Hsinchu County (TW); Heng-Jia Liu, Hsinchu County (TW); KOJI ASAGA, Hsinchu County (TW); Cheng-Wei Hsu, Hsinchu County (TW)

(73) Assignee: BRIGHTEST TECHNOLOGY TAIWAN CO., LTD., Hsinchu County (TW)

(21) Appl. No.: 19/199,341

(22) Filed: May 5, 2025

Related U.S. Application Data
(63) Continuation-in-part of application No. 19/073,038, filed on Mar. 7, 2025.

(51) Int. Cl. G01N 21/95

(52) U.S. Cl. CPC G01N 21/9501; G01N 2201/06113; G01N 2201/0636; G01N 2201/068

(57) ABSTRACT

A radiation generator includes a radiation source configured to provide input radiation, at least one solid medium optically coupled to the radiation source, and a non-solid medium optically coupled to the at least one solid medium. The at least one solid medium is configured to convert the input radiation at least into first radiation via at least one first nonlinear process. A first frequency of the first radiation is higher than an input frequency of the input radiation. The non-solid medium is configured to convert the first radiation at least into second radiation via a second nonlinear process. A second frequency of the second radiation is higher than the first frequency. One of the at least first nonlinear process is a sum frequency generation process, a second harmonic generation process, a third harmonic generation process. The second nonlinear process is a third harmonic generation process.

### CROSS REFERENCE TO RELATED APPLICATIONS

This application is a continuation-in-part of U.S. application Ser. No. 19/073,038, filed on Mar. 7, 2025, which claims the benefit of U.S. Provisional Application No. 63/566,665, filed on Mar. 18, 2024. The contents of these applications are incorporated herein by reference.

### BACKGROUND OF THE INVENTION

### 1. Field of the Invention

The present invention relates to a radiation generator, an inspection device, and a radiation generation method, and more particularly, to a radiation generator, an inspection device, and a radiation generation method that improve resolution, material contrast, throughput, and contamination.

### 2. Description of Prior Art

The challenge of optical wafer defect inspection has intensified as feature sizes on wafers shrink. Smaller defects are increasingly difficult to detect due to limitations in optical resolution. By decreasing the wavelength of radiation, it is possible to resolve smaller structures, increase sensitivity to structural variations, or improve defect detectability because optical resolution is inversely proportional to wavelength. However, inspection using short-wavelength light (e.g., extreme ultraviolet (XUV)) is highly sensitive to both thickness and material. When it comes to wafers with multi-layered structures, variations in materials or thicknesses (under short-wavelength light) can result in different inspection qualities (e.g., resolution). Besides, even with the use of short-wavelength light, low material contrast among the materials used on the wafers can make certain defects undetectable and decreases the signal-to-noise ratio (SNR) in detection. Furthermore, generating short-wavelength light introduces challenges such as conversion efficiency (or light intensity), bandwidth, polarization, spectral purity, resolution, or contamination management. However, these challenges are critical to the performance of light sources of semiconductor inspection equipment.

### SUMMARY OF THE INVENTION

It is therefore a primary objective of the present application to provide a radiation generator, an inspection device, and a radiation generation method, to improve over disadvantages of the prior art.

An embodiment of the present invention discloses a radiation generator, comprising a radiation source, configured to provide input radiation; at least one solid medium, optically coupled to the radiation source, and configured to convert the input radiation at least into first radiation via at least one first nonlinear process, wherein a first frequency of the first radiation is higher than an input frequency of the input radiation; and a non-solid medium, optically coupled to the at least one solid medium, and configured to convert the first radiation at least into second radiation via a second nonlinear process, wherein a second frequency of the second radiation is higher than the first frequency; wherein one of the at least first nonlinear process is a sum frequency generation process, a second harmonic generation process, a third harmonic generation process; wherein the second nonlinear process is a third harmonic generation process.

An embodiment of the present invention discloses an inspection device, for inspecting an object patterned by a lithographic process, comprising a radiation source, configured to provide input radiation; at least one channel, optically coupled to the radiation source, wherein each of the at least one channel comprises at least one medium, configured to frequency-convert the input radiation; and a recipe controller, optically coupled to the at least one channel, and configured to select one from the at least one channel according to characteristics of the object, such that the select channel is configured to convert the input radiation to second radiation.

An embodiment of the present invention discloses a radiation generation method, for outputting second radiation of a target wavelength, comprising emitting input radiation from a radiation source; adjusting, by a spectrum shaper, a wavelength of the input radiation according to the target wavelength; and exciting at least one medium of one of at least one channel for frequency conversion; wherein a recipe controller is configured to select one from the at least one channel, such that the select channel is configured to convert the input radiation adjusted into the second radiation of the target wavelength.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 are schematic diagrams of devices according to embodiments of the present invention.

FIGS. 4-5 are schematic diagrams of wavelength separators according to embodiments of the present invention.

FIG. 6 is a schematic diagram of spectrum shapers according to embodiments of the present invention.

FIGS. 7-9 are schematic diagrams of polarization switchers according to embodiments of the present invention.

FIG. 10 is a schematic diagram of a device according to an embodiment of the present invention.

### DETAILED DESCRIPTION

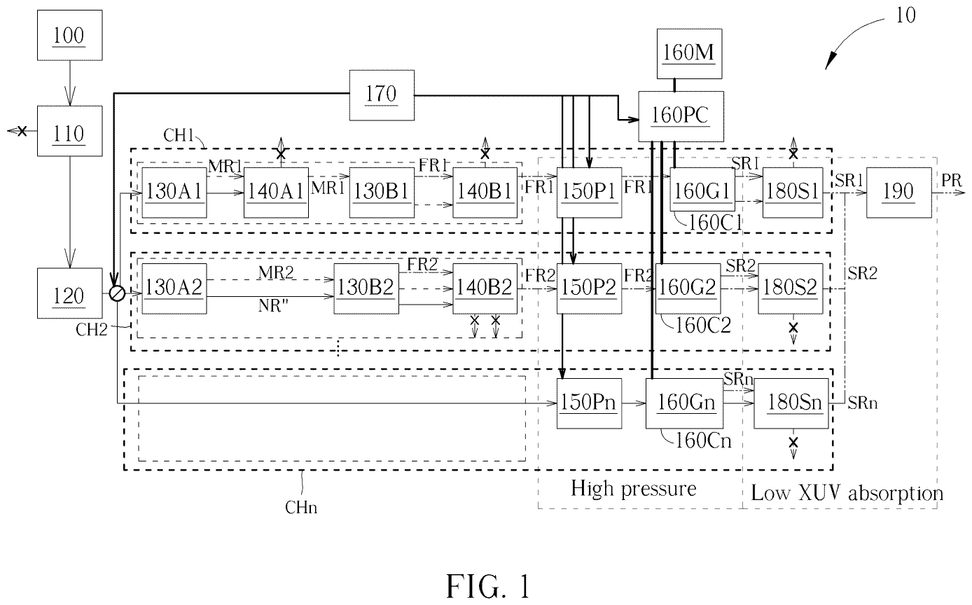

To emit high-power light, the present invention proposes a device 10 (e.g., an inspection device, a lithography light source, or a radiation generator) shown in FIG. 1. The device 10 comprises a radiation source 100 and channel(s) (e.g., CH1... or CHn).

The radiation source 100 provides input radiation (e.g., a sequence of light pulses or a beam of light) and may be a high-power, high-repetition, sub-picosecond pulse laser, which may serve as a pump source. The input radiation may be in the infrared (IR) range.

In FIG. 1, 3-5, or 7-10, different types of radiation are represented by distinct arrow styles: thin solid arrows for IR, thin dashed arrows for visible light, thin dot-dashed arrows for ultraviolet (UV), and thin dot-dot-dashed arrows for extreme ultraviolet (XUV).

Each channel is divided into at least one stage. In each (wavelength converting) channel, at least one medium in at least one stage converts the frequency range of the input radiation into a higher one to achieve higher resolution for detecting small defects or features on an object. For example, the channel CH1 comprises solid mediums 130A1, 130B1, and a non-solid medium 160G1. In the first stage, the solid medium 130A1 converts the input radiation at least into intermediate radiation MR1 (e.g., visible light) via a nonlinear process (e.g., a second harmonic generation (SHG) process). In the second stage, the solid medium 130A1 converts the intermediate radiation MR1 at least into first radiation FR1 (e.g., UV light) via another nonlinear process (e.g., another SHG process). In the last stage, the non-solid medium 160G1 converts the first radiation FR1 at least into second radiation SR1 (e.g., XUV light) via the other nonlinear process (e.g., a third harmonic generation (THG) process). In other words, a portion of the input radiation is converted into higher-frequency, higher-power radiation in a cascade manner, dividing an overall nonlinear process (e.g., high-order harmonics generation) into a succession of nonlinear processes/stages (e.g., a series of low-order harmonics generation). This design enables the device 10 to produce a spectrum different from that of the radiation source 100.

The nonlinear materials/processes used in the channels CH1-CHn may be different, resulting in each channel generating a unique spectrum for its second radiation SR1... or SRn. For example, a solid medium 130B2 of the channel CH2 may produce higher-frequency radiation FR2 based on a sum frequency generation (SFG) technique. The channel CH3 may generate higher-frequency radiation using solid or non-solid medium(s) via at least one nonlinear process (e.g., a SHG process, a THG process, a SFG process, an optical parametric amplification (OPA) process, or the combination thereof). The channel CHn may convert the input radiation at least into higher-frequency radiation SRn merely using a non-solid medium 160Gn. The different materials/composition of the mediums 130A1, 130A2, 160G1, ..., or 160Gn may also cause the spectrums of the second radiation SR1-SRn to differ across channels. Moreover, the frequency ranges of the second radiation SR1-SRn may be non-overlapping or at least partially non-overlapping.

By sophisticatedly selecting materials and nonlinear processes, every stage (e.g., 130A2) outputs radiation (e.g., MR2) with optimal conversion efficiency (or throughput), and every channel (e.g., CH2) achieves optimal conversion efficiency for its second radiation (e.g., SR2). Together, the spectrums of the second radiation SR1... or SRn constitute output radiation PR with high conversion efficiency for the device 10.

Combining the second radiation SR1-SRn enables the output radiation PR to form a broad (discrete, nearly-continuous, or continuous) spectrum, substantially broader than any individual second radiation SR1-SRn. In contrast to narrow-band systems, a broadband approach of the device 10 offers more solutions for fitting algorithm(s) in two-dimensional pattern recognition, particularly when it deals with fluctuations or noise. Additionally, since the reflectivity of an object varies as a function of radiation wavelength, a broadband approach of the device 10 provides more potential to enhance the contrast of a targeted object's reflectivity with other materials'reflectivity. Consequently, the broader spectrum (e.g., 50-120 nanometers) of the device 10, which can improve mathematical/curve fitting and material contrast, facilitate optical inspection for wafers with various materials or thicknesses.

The device 10 may also comprises a recipe controller 170 (e.g., a host computer, a microprocessor, a central processing unit, or a circuit controlled by a host computer) to determine/adjust the final spectrum of the output radiation PR. For example, when the device 10 serves as an inspection device for inspecting a (patterned) object, the recipe controller 170 may select at least one channel (e.g., CH1 and CH2) from the channels CH1-CHn according to the object's characteristics (e.g., dimension or material composition). The selected channel(s) (CH1 and CH2) of the device 10 convert(s) the input radiation into the second radiation (e.g., SR1 and SR2), which is then combined to form the output radiation PR with appropriate spectrum, and function(s) as an equivalent light source, which may be distinct from another equivalent light source formed by (different or partial different) channel(s) of the device 10. This customizable spectrum (e.g., 45-55, 50-70, or 80-110 nanometers) of the device 10 enhances material contrast, making the reflectivity of the object higher than that of dirt/debris/defect(s) or neighboring components of different materials/thicknesses. Accordingly, the object (e.g., a patterned feature of a wafer after/during development/etching, transistor(s), drain(s)/source(s), metal contact(s), a metal-zero (M0), or metal-one (M1) layer) is distinguishable from dirt/debris/defect(s) or other components, especially in comparison to laser produce plasma (LPP), discharge produce plasma (DDP), or HHG.

Besides, the device 10 may switch from a channel (e.g., CH1) outputting a certain frequency band (e.g., 50 Hz) to another channel (e.g., CH2) outputting a different frequency band (e.g., 60 Hz) to change the final spectrum of the output radiation PR when transitioning, for example, from inspecting the metal-zero layer to examining the drain of a transistor.

As set forth above, a channel may comprise solid medium(s) (e.g., 130A1... 130B2) for frequency up-conversion since solid mediums can be easily controlled and flexibly placed. A solid medium may comprise solid-state material(s) such as Beta-Barium Borate (BBO), Potassium Titanyl Phosphate (KTP), Lithium Triborate (LBO), Periodically Poled Lithium Niobate (PPLN), or Cesium Lithium Borate (CLBO). The conversion efficiency of a solid medium (130A1... or 130B2) may be maximized by adjusting pump parameters (e.g., fundamental beam chirp, intensity, or central wavelength), achieving phase matching, or adjusting crystal parameters (e.g., nonlinear coefficients). Phase matching may be achieved by adjusting temperature, the incident angle, the tilt, yaw, or rotation angle of the solid medium.

To improve solid conversion efficiency, a (dual band) half-wave plate (not shown) or a (group velocity) compensate plate (not shown) may be inserted between two adjacent solid mediums (e.g., 130A2 and 130B2) in a channel (e.g., CH2). By adjusting the tunable compensate plate, which may be disposed before the half-wave plate, time delay can be corrected. The half-wave plate rotates the polarization of the converted input radiation NR″ (e.g., the fundamental), such that the polarization of the converted input radiation NR″ and the polarization of the intermediate radiation MR2 (e.g., the second harmonic) are aligned. The conversion efficiency is maximized due to precise polarization alignment and optimal temporal overlap.

As set forth above, a channel may comprise a non-solid medium (e.g., 160G1... or 160Gn), which interacts with (first/input) radiation (e.g., FR1) at a fundamental frequency (e.g., 343 or 257 nanometers) to generate (second) radiation (e.g., SR1) at a tripled frequency (e.g., 114 or 85 nanometers) when THG occurs within the non-solid medium. The term “non-solid medium” inherently implies it is gaseous or liquid, and, for example, may comprise a gas (e.g., helium (He), neon (Ne), argon (Ar), krypton (Kr), or xenon (Xe)), a gas mixture (e.g., the gas ratio of heavy atomic weight to light atomic weight is between 1:1 and 1:300), a liquid, a liquid mixture, or a combination thereof.

Non-solid approach enhances throughput, lifetime, and conversion efficiency with less contamination. Unlike solid, which is susceptible to damage from (higher-frequency) light, a non-solid medium (e.g., 160G2) has an advantage of longer throughput lifetimes and higher conversion efficiency in the same photon energy range. Besides, a non-solid medium is ideal for XUV or UV frequencies as it typically exhibits lower absorption than a solid medium. A non-solid medium used as wavelength converting material also reduces contamination compared to, for example, LPP or laser sustain plasma (LSP). An inspection device requires not only high throughput but also minimal contamination since an inspecting process should not introduce defects/debris onto the inspected object. The device 10 thus adopts gas or liquid instead of plasma.

In another aspect, a channel may incorporate solid medium(s) and a non-solid medium to improve conversion efficiency or beam profile/quality. For example, a non-solid medium may locate at/near the focal plane of the first/input radiation (e.g., FR1) incident into the non-solid medium (e.g., within three Rayleigh ranges of the focal plane), while solid medium(s) may be placed at some distance before the focal plane (e.g., at a location between three and ten Rayleigh ranges from the focal plane). After the input/intermediate radiation (e.g., MR1) encounters a solid medium (e.g., 130B1), the remaining input/intermediate radiation (also referred to as third radiation) and the first radiation (e.g., FR1) leave the solid medium. The first radiation, generated within the solid medium, is subsequently incident on a non-solid medium (e.g., 160G1), where the remaining first radiation (also referred to as fourth radiation) and the second radiation (e.g., SR1), which is generated within the non-solid medium, continue to propagate. In this way, radiation from the solid medium(s) interacts with the non-solid medium for a cascade nonlinear mechanism.

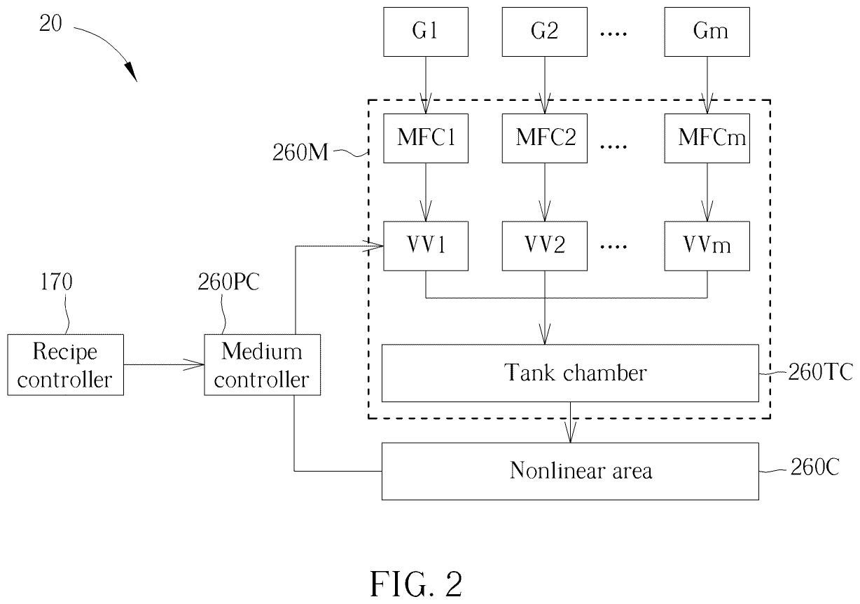

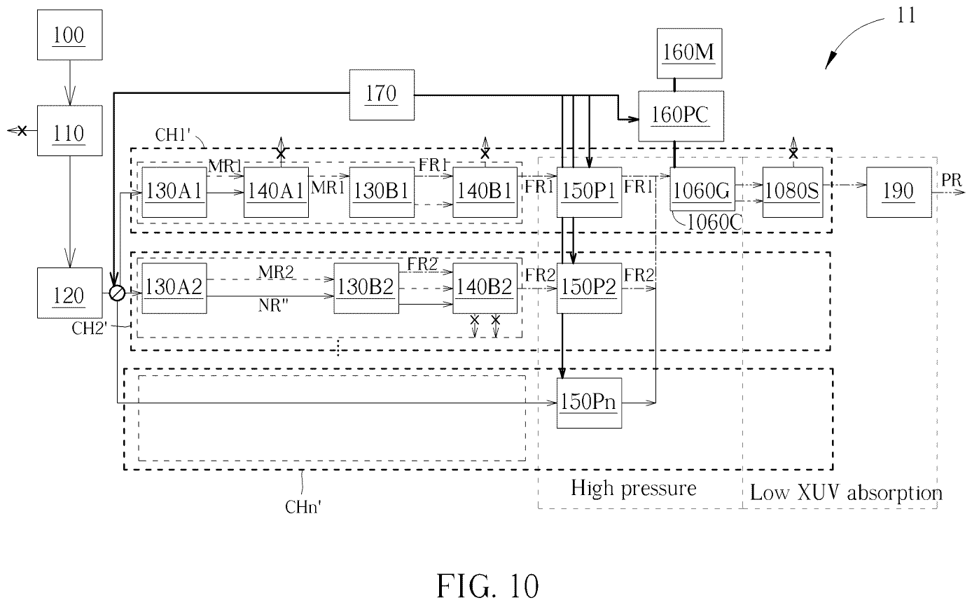

In FIG. 1, each of the channels CH1-CHn comprises one of the non-solid mediums 160G1-160Gn, which substantially reside in (independent) nonlinear areas 160C1-160Cn (e.g., n chambers), respectively. However, it is possible to integrate at least two of the separate nonlinear areas 160C1-160Cn into one single nonlinear area (e.g., 260C shown in FIG. 2 or 1060C shown in FIG. 10), which may switch between the non-solid mediums (e.g., 160G1... or 160Gn) as needed.

For example, FIG. 2 is a schematic diagram of a device 20, which may be implemented using the device 10, according to an embodiment of the present invention. The device 20 comprises the nonlinear area 260C.

To enable switching from one non-solid medium (e.g., 160G1) to another (e.g., 160G2) within a single nonlinear area (e.g., 260C), the substance composition or ratio within this nonlinear area must be adaptable. Therefore, the device 20 comprises a mixer 260M and a medium controller 260PC, which control the substance type, mixture ratio, pressure, or other properties of a non-solid medium within the nonlinear area 260C. For example, mass flow controllers MFC1-MFCm or (pneumatic solenoid) valves VV1-VVm of the mixer 260M manages the flow rates of constituent non-solid substances G1-Gm. Opening the valve VV1 while keeping the valves VV2-VVm closed allows the non-solid medium 160G1 to fill a tank chamber 260TC or the nonlinear area 260C. Alternatively, when the valves VV1-VV2 are opened and the valves VV3-VVm are closed, the device 20 can fill the nonlinear area 260C with the non-solid medium 160G2. By opening/closing the valves VV1-VVm, the nonlinear area 260C may switch between the non-solid mediums (e.g., 160G1-160G2).

Through the mass flow controllers MFC1-MFCm or the valves VV1-VVm, the device 20 may achieve the desired mixture ratio in the nonlinear area 260C. Besides, the medium controller 260PC monitors the substance/ratio/pressure of the non-solid medium within the nonlinear area 260C and feeds back the mixer 260M to open/close the valves VV1-VVm, thereby maintaining the desired mixture ratio.

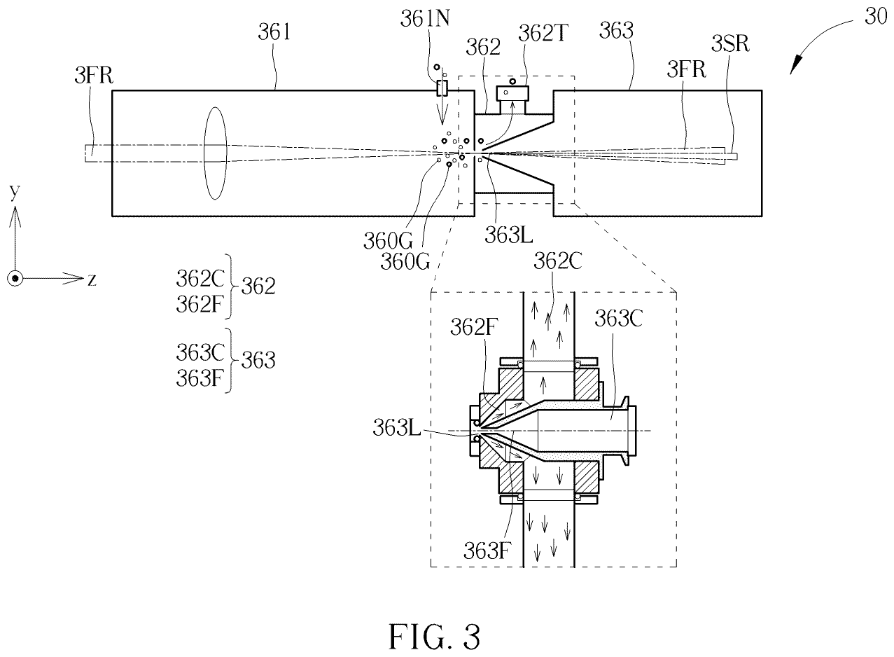

A gas mixture within the nonlinear area 260C may comprise not only gas for frequency converting (e.g., gas particles represented by small thin circles in FIG. 3) but also gas for phase matching compensation (e.g., gas particles shown as big thick circles in FIG. 3), such that the phase is adjusted to maximize its combined effect. A gas mixture may also broaden the frequency conversion bandwidth of the nonlinear area 260C because different materials exhibit varying degrees of nonlinearity at different frequencies.

Referring back to FIG. 1, to stabilize the pressure or concentration of the non-solid mediums 160G1-160Gn in the nonlinear areas 160C1-160Cn, the device 10 may also comprise a mixer 160M and a medium controller 160PC, which may be implemented using the mixer 260M and the medium controller 260PC, respectively. The mixer 160M/260M or the medium controller 160PC/260PC is controlled by the recipe controller 170 to ensure precise control over fluid mixing ratios and pressure.

FIG. 3 is a schematic diagram of a cross-section view of a device 30, which may be implemented using the device 10, according to an embodiment of the present invention. The device 30 is classified at least into a nonlinear area 361 and a low absorption area 363.

The nonlinear area 361, for converting (first/input) radiation 3FR into (second) radiation 3SR, holds a non-solid medium (e.g., 160G1 ... or 1060G) of high pressure (e.g., 3-2000 Torr) to enhance nonlinearity. The nonlinear area 361 may be implemented using the nonlinear area 160C1 ... or 260C. The total length of the nonlinear area 361, along the optical path for frequency converting, may exceed half the confocal parameter (e.g., 1-20 millimeters). As shown in FIG. 3, the nonlinear area 361 may take the form of a semi-infinite chamber, which is longer than Rayleigh range or coherent length. Alternatively, the nonlinear area 361 may be implemented using a hollow core fiber. Alternatively, the (first/input) radiation 3FR is focused on or in front of a continuous or pulsed gas jet, where the non-solid medium (e.g., 160G1 ... or 1060G) is emitted perpendicular to the optical path.

Because the radiation 3SR generated at the nonlinear area 361 can be heavily absorbed by, for example, air, nitrogen, or other gas, the low absorption area 363 is located after the nonlinear area 361 to avoid absorption/reabsorption. The low absorption area 363 with low XUV absorption may be (nearly) evacuated (e.g., less than e⁻³ Torr or less than 3 Torr), or filled with low XUV absorption gas (e.g., Helium with 500-800 Torr) or a non-solid substance of higher ionization energy. As a result, the radiation 3SR may propagate further without undue attenuation. For example, in the low absorption area 363, an attenuation length (i.e., a propagation distance over which power drops to 1/e) is more than 20 centimeters for wavelengths between 50-120 nanometers.

As shown in FIG. 3, the device 30 may further comprise a buffer area 362, such that the nonlinear area 361 and the low absorption area 363 do not exchange/interfere. The non-solid medium (e.g., 160G1 ... or 1060G) may be pumped into the nonlinear area 361 through an opening 361N, while it or other substance is pumped out of the low absorption area 363 through another opening 362T. A vacuum (e.g., less than 0.2 Torr) may thus be maintained in the buffer area 362 to physically isolate the nonlinear area 361 and the low absorption area 363. This differential pumping geometry minimize the disturbance of fluid mixing ratio in the nonlinear area 361 and avoids reabsorption.

To enhancing pumping, as shown in FIG. 3, the low absorption area 363 or the buffer area 362 substantially tapers toward an outlet 363L leading into the nonlinear area 361. The diameter of the outlet 363L may be up to three times the beam width. Alternatively, the low absorption area 363 comprises a cylinder tube 363C and a funnel tube 363F, which is wide at one end and narrow at the other end. The buffer area 362 comprises a cylinder pipe 362C and a funnel pipe 362F, which encloses the tube 363F. The pipe 362F also widens at one end and narrows at the other to direct the non-solid medium or other substance smoothly from the outlet 363L. The pipe 362C is oriented perpendicular to the tube 363C. The structure may be constructed according to fluid mechanics to guide the flow properly (e.g., from the opening 361N toward the opening 362T).

Alternatively, to isolate the nonlinear area 361 from the low absorption area 363, the nonlinear area 361 may be blocked, which prevents non-solid medium(s) or debris/dirt from entering to the low absorption area 363. This may be achieved by incorporating a wavelength separator (e.g., one shown in FIGS. 1, 4, 5, or 10) in place of the buffer area 362. However, as shown in FIG. 3, debris/dirt may be drawn out through the buffer area 362, along with the non-solid medium(s), to reduce contamination risks.

Referring to FIGS. 1 and 3, since the low absorption area 363 has low XUV absorption and longer attenuation length, an (XUV) illuminator 190, which manipulates/emits the output radiation PR, may be placed within the low absorption area 363 as well. The object exposed to the output radiation PR may be also placed within the low absorption area 363.

Referring to FIG. 1, to separate the desired bandwidth from other frequencies efficiently, the device 10 further comprises wavelength separator(s) 140A1... or 180Sn in each channel. The wavelength separator(s) is/are (nearly) opaque to unwanted radiation but at least partially transparent to the desired radiation, and thus spectral purity for the illuminator 190 is improved to reduce noise. For example, in the channel CH1, the wavelength separator 140A1 and 140B1, disposed after the solid mediums 130A1 and 130B1, filter out IR and visible frequencies to extract visible and UV frequencies, respectively. Besides, the wavelength separator 180S1, disposed after the non-solid medium 160G1, remove UV frequencies to isolate XUV frequencies. Even if the ratio of shorter frequencies (e.g., XUV) to longer frequencies (e.g., UV) may be low, a wavelength separator filtering out longer wavelengths allows signals corresponding to shorter wavelengths to stand out more distinctly.

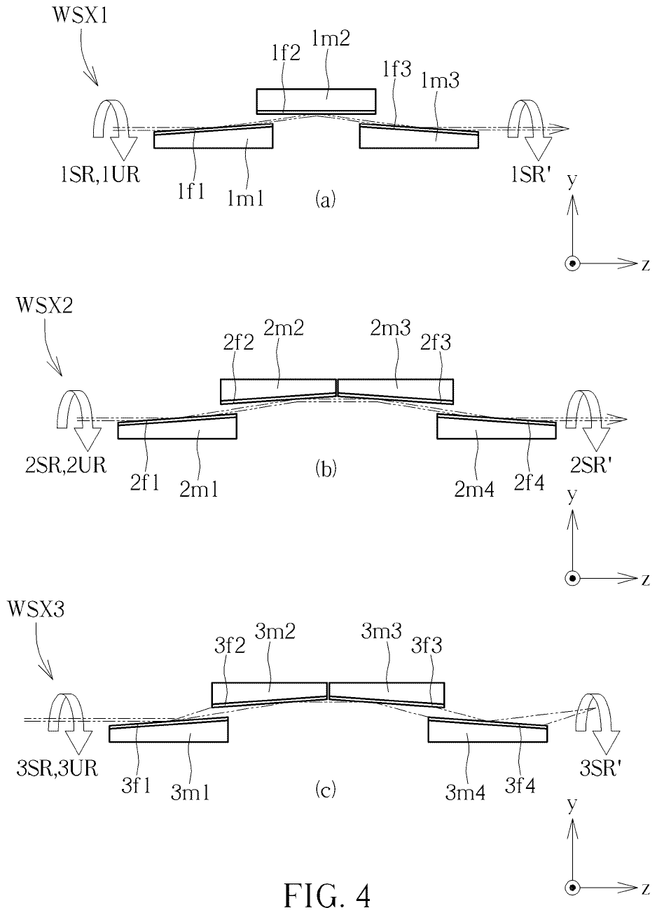

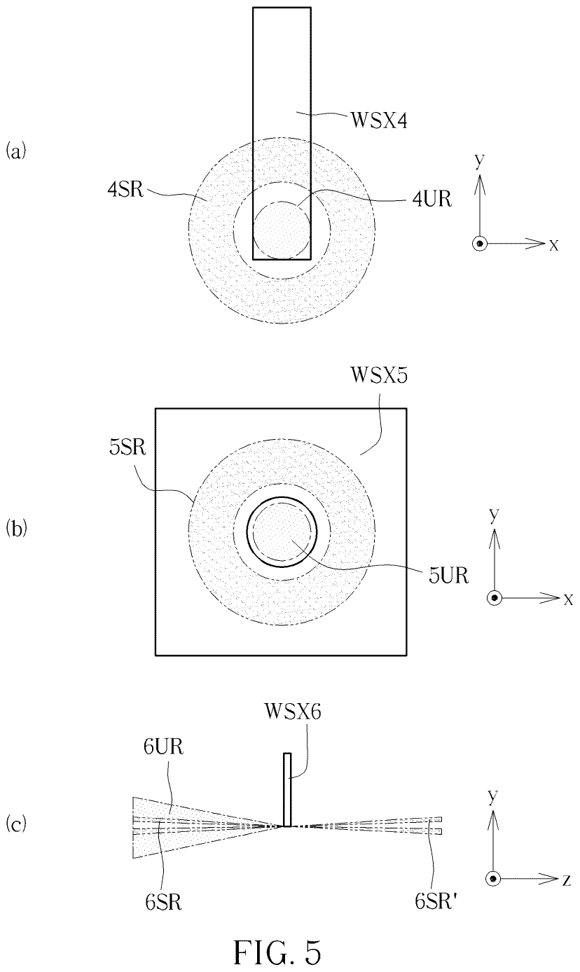

Each wavelength separator (e.g., 140A1 ... or 180Sn) may be implemented using a bandpass filter (e.g., thin metallic film), a dichroic mirror, a grating/prism, a spatial filter, or a combination thereof. Alternatively, each wavelength separator (e.g., 180S1 ... or 180Sn), especially one in XUV regime (e.g., wavelength less than 120 nanometers), may be implemented using one of wavelength separators WSX1-WSX5 shown in FIG. 4 or FIG. 5. In other words, the structure of a wavelength separator in XUV regime may differ from that in IR, visible, or UV regime. Besides, the wavelength separators 180S1-180Sn in XUV regime for the channels CH1-CHn may differ in spectrum.

FIG. 4 (a)-(c) illustrate that (second) radiation 1SR-3SR are retained while (fourth) radiation 1UR-3UR are removed by the wavelength separators WSX1-WSX3, respectively. The radiation 1UR... or 3UR is the portion of the (first/input) radiation (e.g., FR1), not converted to XUV frequencies in the previous nonlinear process. The (second) radiation 1SR′-3SR′ represent the filtered (second) radiation 1SR-3SR, exiting the wavelength separators WSX1-WSX3, respectively.

As shown in FIG. 4 (a), the wavelength separator WSX1 comprises dichroic mirrors 1m1-1m3, with dichroic coatings on surfaces 1f1-1f3. The surfaces 1f1 and 1f2, which face each other across the optical path, substantially form an acute angle, while the surfaces 1f1 and 1f3, tilted toward the surface 1f2, substantially form an obtuse angle.

The wavelength separator WSX1 leverages reflection rather than transmission since reflectivity is normally higher for XUV band. Specifically, the surface 1f1 reflects the desire wavelengths and allows other wavelengths to pass through, thereby filtering out UV frequencies and extracting XUV frequencies. Similar reflection/transmission is repeated by the surface 1f2. The cumulative effect down the sequence results in an ultimate output of the desired radiation 1SR′ from the surface 1f3. Because of high reflectivity, the wavelength separator WSX1 efficiently preserves most of the desired radiation 1SR with minimal attenuation.

The radiation 1SR, entering the wavelength separator WSX1, is coaxial to the radiation 1SR′, exiting the wavelength separator WSX1. This alignment may be achieved by the symmetric arrangement of the dichroic mirrors 1m1 and 1m3 relative to an axis of the dichroic mirror 1m2. Compared to a two-dichroic-mirror configuration, the three dichroic mirrors 1m1-1m3 may cause less pointing variation and displacement.

The wavelength separator WSX1 demonstrates an extended operational lifetime. Since the incident angle of the (second/fourth) radiation (e.g., 1SR) on a surface (e.g., 1f1) is substantially large (e.g., larger than 60 or 65 degrees), the energy is distributed over a larger cross-sectional area, thereby reducing the energy per unit area. This design minimizes potential damage, even with high photon energy in XUV regime and limited heat dissipation in a vacuum, and results in a longer lifetime for the wavelength separator WSX1 due to its elevated damage threshold.

As shown in FIG. 4 (b), the wavelength separator WSX2 comprises dichroic mirrors 2m1-2m4, with parallel surfaces 2f1 and 2f2 as well as parallel surfaces 2f3 and 2f4. The angle between the adjacent surfaces 2f2 and 2f3 may be substantially obtuse. Since the dichroic mirrors 2m1-2m4 are symmetric relative to a common boundary of the dichroic mirrors 2m2-2m3, the radiation 2SR, entering the wavelength separator WSX2, is coaxial to the radiation 2SR', exiting the wavelength separator WSX2.

The more dichroic mirror, the higher extinction ratio and the throughput. For example, as each dichroic mirror offers an extinction ratio higher than 30:1 or throughput higher than 80%, the wavelength separator WSX2 achieves an overall extinction ratio exceeding 100,000:1 or throughput greater than 40%. In other words, by incorporating more dichroic mirrors, the wavelength separator WSX2 can preserve more high-frequency radiation and filter out most fundamental wavelength, thereby optimizing throughput for the desire high frequency.

The shape of a surface may vary to add more function. In the wavelength separator WSX3 of FIG. 4 (c), surface(s) (e.g., 3f1 ... or 3f3) of certain dichroic mirror(s) (e.g., 3m1 ... or 3m3) may be flat. However, at least one surface (e.g., 3f4) of the wavelength separator WSX3 may be curved, ellipsoidal, concave, or convex. The wavelength separator WSX3 may serve as a collector, for example, when the last two surfaces 3f3-3f4 are curved.

Using rotation stage(s) or linear stage(s), the wavelength separators WSX1-WSX3 are adaptable to arbitrary linear polarization. Since the coating surface of a dichroic mirror may favor certain polarization, the wavelength separator (e.g., WSX1) may be rotated by a rotation stage to align its preferred polarization with the polarization of the (second) radiation (e.g., 1SR). Alternatively, a linear stage inserts a wavelength separator (e.g., WSX1) with suitable polarization (e.g., s-polarization) into the optical path and removes the other wavelength separator with perpendicular polarization (e.g., p-polarization) out of the optical path. The movement of a rotation or linear stage may be controlled by the recipe controller 170 or a host computer. In other words, regardless of the polarization of the (second) radiation, the polarization of the wavelength separators WSX1-WSX3 can be adjusted to be compatible with the (second) radiation. In another aspect, a rotation or linear stage allows a wavelength separator (e.g., WSX1) to select not only the desired wavelength(s) but also the desired polarization.

FIG. 5 (a)-(c) illustrate that (second) radiation 4SR-6SR are retained while (fourth) radiation 4UR-6UR are removed by the wavelength separators WSX4-WSX6, respectively. The radiation 4UR... or 6UR is the portion of the (first/input) radiation (e.g., FR1), not converted to XUV frequencies in the previous nonlinear process. The (second) radiation 6SR′ represents the filtered (second) radiation 6SR, exiting the wavelength separator WSX6.

The spatial distribution of the (fourth) radiation (e.g., 4UR) may differ from that of the (second) radiation (e.g., 4SR) during propagation. Specifically, as shown in FIG. 5 (c), the intensity cross-section of the second or fourth radiation may be annular or hollow; however, the present invention is not limited to these shapes and may also feature a Gaussian, circular, or other cross-sectional profile. The focal planes or the shapes of the radiation 4SR and 4UR may be different. Consequently, as shown in the transverse intensity profile of FIG. 5 (a), in a position along the optical path, the radiation 4UR, propagating along the optical axis, may have a Gaussian/circular cross-section (i.e., the fundamental intensity profile), while the radiation 4SR, generated in the previous nonlinear process, may also propagate along the optical axis but exhibit an annular/hollow cross-section (i.e., the XUV intensity profile). That is, each frequency (component) of the radiation 4UR substantially has a Gaussian/circular cross-section, and each frequency (component) of the radiation 4SR substantially has an annular/hollow cross-section. The annular cross-section of the radiation 4SR may partially overlap or not overlap with the circular cross-section of the radiation 4UR, which may be enclosed by the annular cross-section, and hence results in a spatial separation between the radiation 4SR and 4UR.

The design of the wavelength separator WSX4 shown in FIG. 5 may leverage the difference in radiation spatial distribution to filter out UV frequencies and extract XUV frequencies. Specifically, the wavelength separator WSX4, positioned downstream from the previous nonlinear process, is shaped to substantially cover the cross-section of the radiation 4UR, and thus blocks the residual radiation 4UR remaining after the previous nonlinear process. The overlap mainly between the wavelength separator WSX4 and the cross-section of the radiation 4UR further allows the generated radiation 4SR to pass through with less clipping.

As shown in FIG. 5 (a) or (c), the wavelength separator WSX4 or WSX6 may be a hard stopper, with a shape that overlaps the circular cross-section, to block the (fourth) radiation 4UR or 6UR. Alternatively, as shown in FIG. 5 (b) or (c), the wavelength separator WSX5 or WSX6 may be a mirror with a hollow or annular shape, and is positioned to substantially overlap the cross-section of the (second) radiation 5SR or 6UR, thereby reflecting and redirecting the (second) radiation 6SR′ to the desired location without clipping.

Since a spatial filter selectively passes the desired (second) radiation (e.g., 6SR′) by simply modifying the cross-sectional intensity distribution of an overall radiation (e.g., 6SR and 6UR), the wavelength separator WSX4 ... or WSX6, serving as a spatial filter, achieves high extinction ratio (higher than 10,000:1) and high throughput (higher than 70%). Besides, this design ensures no pointing variation and displacement, and the wavelength separator (e.g., WSX6) can be adapted to arbitrary linear polarization.

Referring back to FIG. 1, to maximize throughput or power, the device 10 further comprises a polarizer 110, configured to enhance polarization purity, or a spectrum shaper 120, configured to optimally shape the wavelength and bandwidth for the subsequent nonlinear process/processes. The spectrum shaper 120 may adjust the wavelength according to the outputting wavelength of the output radiation PR. This configuration allows the illuminator 190 to deliver the output radiation PR of high luminance. The spectrum shaper 120 can be implemented by a band pass filter or a Raman shifter, but the invention is not limited herein.

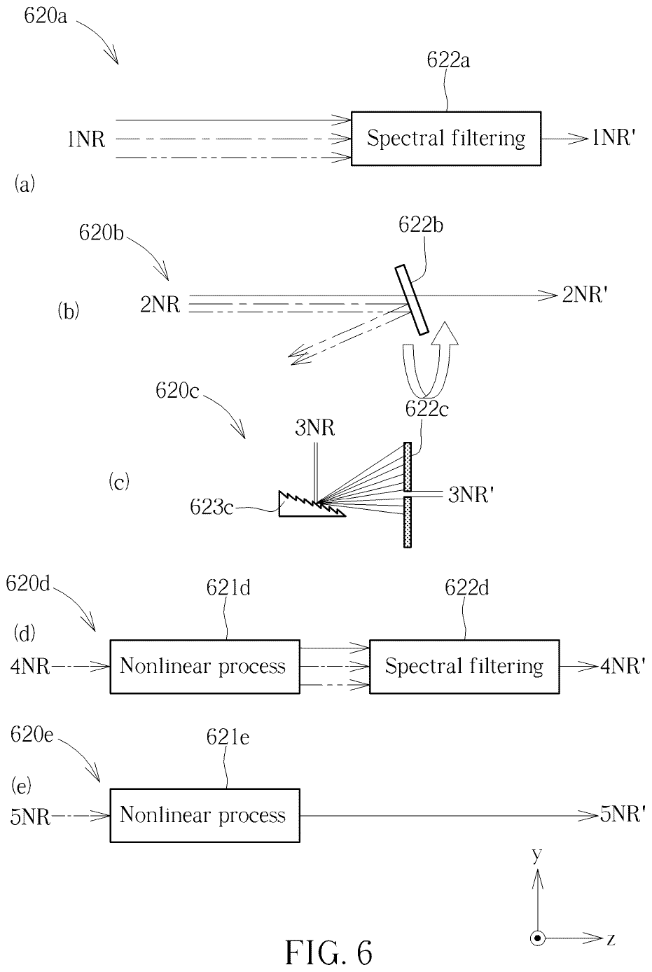

FIG. 6 is a schematic diagram of spectrum shapers 620a-620e, which may be used to implement the spectrum shaper 120, according to an embodiment of the present invention. In FIG. 6, thin solid arrows, thin dot-dashed arrows, and thin dot-dot-dashed represent (input) radiation at IR frequencies. A spectrum shaper in FIG. 6 (a) ... or (e) may comprise a nonlinear processing means (e.g., 621d or 621e) or a spectral filtering means (e.g., 622a, 622b, 622c, or 622d).

The nonlinear processing means 621d or 621e may be implemented using a spectral broadening device (e.g., exploiting self-phase modulation (SPM), multi-plate super continuing (MPSC), or gas-zone broadening (GZB) technique) or a spectral shifting device (e.g., exploiting Raman shift of Raman gas) to generate a shifted wavelength range.

The spectral filtering means 622a or 622d, which selectively allows only desired wavelengths to pass but blocks all the others, may be implemented using the spectral filtering means 622b (e.g., a tunable bandpass filter) or the spectral filtering means 622c, which comprises a slit 622c and a grating (or prism) 623c.

As a result, the spectrum shaper (e.g., 620a... or 620e) may change the central wavelength of the (input) radiation (e.g., 1NR ... or 5NR) to that of the (input) radiation (e.g., 1NR′... or 5NR′), which satisfy the oscillation state(s) of non-solid medium(s) (e.g., 160G1 or 1060G) in XUV generation process (e.g., 1030 nanometers). Besides, the spectrum shaper may fine-tune the bandwidth (e.g., changing from 10 nanometers to below 2 nanometers) of the (input) radiation (e.g., 1NR ... or 5NR) to optimize bandwidth to meet phase-matching conditions for solid or non-solid medium(s), improve lifetime of solid or non-solid medium(s), or increase conversion efficiency. In other words, the spectrum shaper (e.g., 620a ... or 620e) may adjust the wavelength of the (input) radiation according to the desired/target wavelength of the output radiation PR, and thus according to the properties of non-solid medium(s).

Referring back to FIG. 1, to achieve the desired polarization, the device 10 further comprises polarization switcher(s) (e.g., 150P1 ... or 150Pn) in each channel. The polarization switchers 150P1-150Pn, which adjust/decide the polarization of the (first/input) radiation (e.g., in UV band or with a wavelength less than 350 nanometers), may be disposed before/after the non-solid mediums 160G1-160Gn.

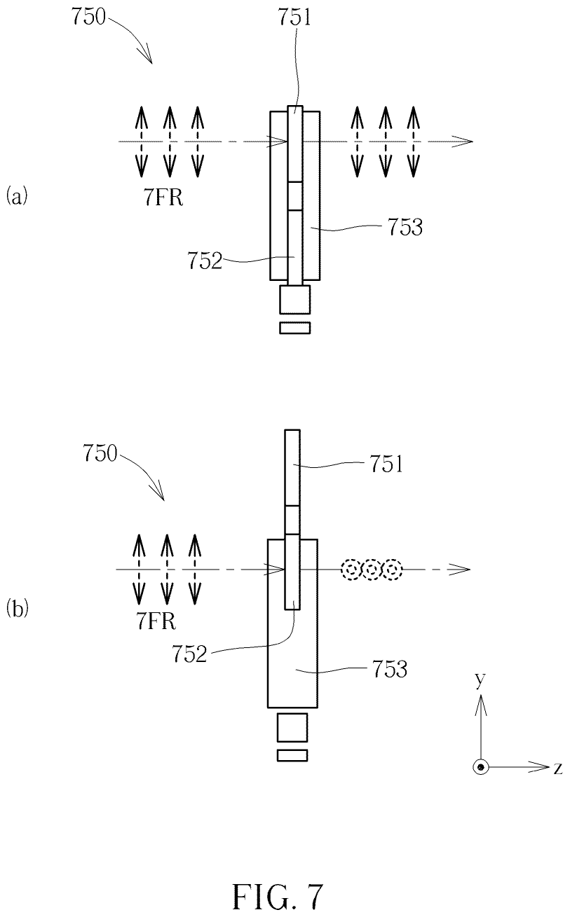

FIG. 7 is a schematic diagram of a polarization switcher 750, which may be used to implement the polarization switcher 150P1 ... or 150Pn, according to an embodiment of the present invention. The polarization switcher 750, or a switchable half-wave plate set, comprises half-wave plates 751, 752, and a (linear) stage 753, which moves/switches the half-wave plates 751, 752.

By switching the half-wave plates 751 and 752, the polarization switcher 750 can adjust the polarization of the radiation 7FR. Specifically, the fast axis of the half-wave plate 751 is angled differently from (e.g., perpendicular to) that of the half-wave plate 752 relative to (first) radiation 7FR. When the half-wave plate 751 shown in FIG. 7 (a) is replaced by the half-wave plate 752 shown in FIG. 7 (b), the polarization of the radiation 7FR is changed (e.g., from p-polarized to s-polarized).

Instead of using a rotation stage to rotate a half-wave plate, the polarization switcher 750 simply requires the linear stage 753 to alternate between the half-wave plates 751 and 752. Because this approach eliminates the need for precise rotational alignment, the polarization switcher 750 is less sensitive to mechanical accuracy.

The polarization switcher 750 can ensure longer lifetime. Even though an individual half-wave plate (e.g., 751 or 752) may have limited lifetime at UV frequencies, a damaged half-wave plate (e.g., 751) can be replaced by a new one (not shown) easily after the damaged one is moved out of the optical path, removed from the stage 753, and swapped with the new half-wave plate (not shown). As a result, the polarization switcher 750 is durable, even under high photon energy of the radiation 7FR.

When the polarization switcher 750 switches from the half-wave plate 751 to the half-wave plate 752, the optical path remains unchanged. However, the present invention is not limited thereto.

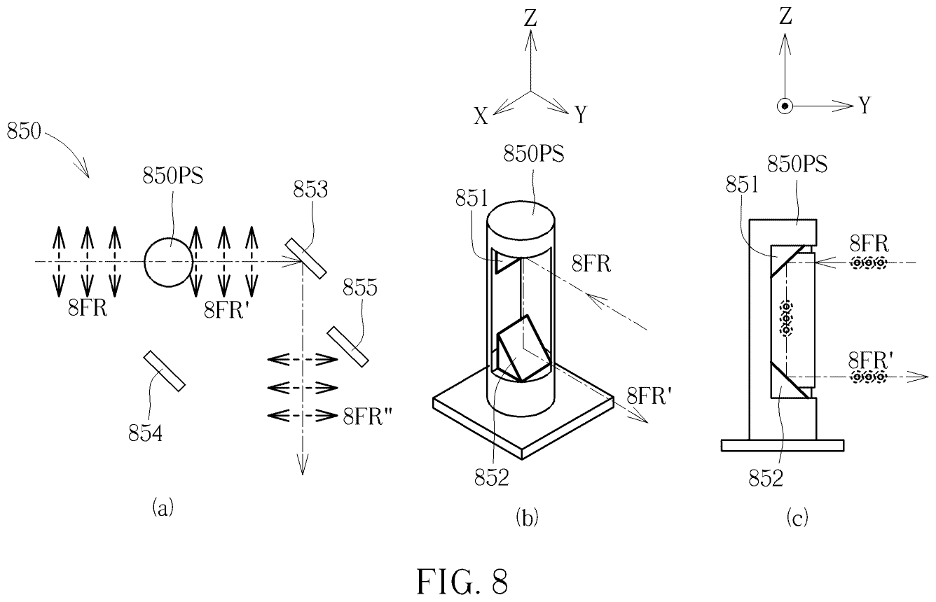

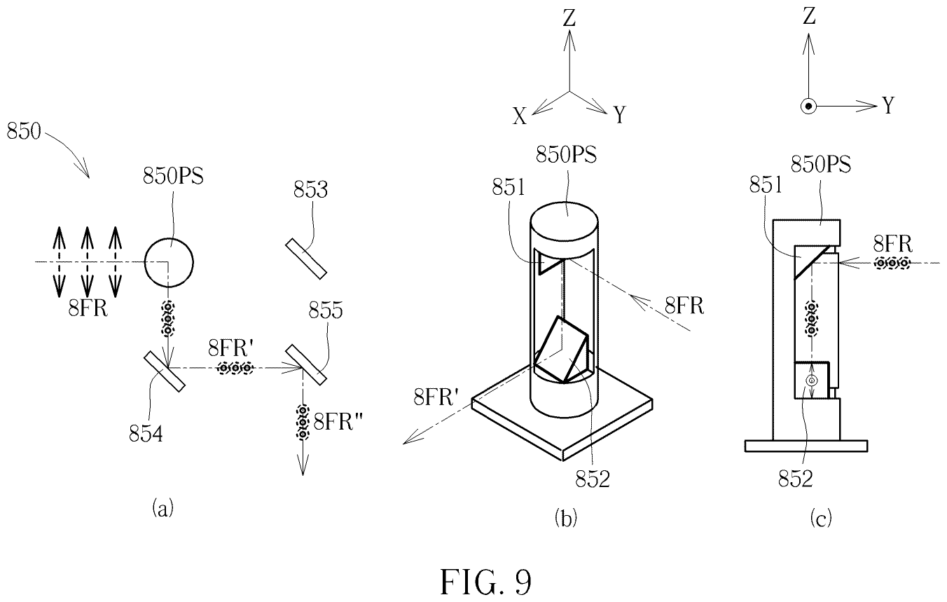

For example, FIGS. 8-9 are schematic diagrams of a polarization switcher 850, which may be used to implement the polarization switcher 150P1 ... or 150Pn, according to an embodiment of the present invention. The polarization switcher 850, serving as a path-dominating switcher, comprises deflectors 851-855 (e.g., mirrors). The deflectors 851-852 may constitute a periscope 850PS, rotatable to alter the polarization of (first) radiation 8FR and guide the radiation 8FR along a distinct optical path based on its polarization. The deflectors 853-855 further adjust the optical path of (first) radiation 8FR′, such that (first) radiation 8FR″ outputted in FIG. 8 is substantially coaxial or follow an optical path similar to that in FIG. 9. In other words, the optical path varies with the polarization of radiation.

The (first) radiation 8FR, 8FR′, and 8FR″ represent the same radiation interacting with different deflectors (e.g., 852, 853, or 855). Each of the radiation 8FR, 8FR′, and 8FR″ may be used to implement the (first) radiation (e.g., FR1) shown in FIG. 1.

As shown in FIG. 8 (b) and (c), the normal vectors of the deflectors 851-852 lie on the same plane (i.e., the plane of incidence), and hence the polarization of radiation 8FR and the polarization of radiation 8FR′ are the same (e.g., horizontally-polarized). In other words, if the deflectors 851-852 are angled such that the radiation 8FR′ is sent parallel to the radiation 8FR (in the same or opposite direction), the polarization remains unchanged. Next, the radiation 8FR′ reflects off the deflector 853. As shown in FIG. 8 (a), the deflector 853 then directs the radiation 8FR″ outward, instead of toward the deflector 855, because the deflector 855 is retracted (by a flipper or a linear/rotation stage). Alternatively, when the deflector 855 is configured as a (polarization) beam splitter rather than a mirror, the radiation 8FR′ may enter the deflector 855 directly.

In contrast, as shown in FIG. 9 (b) and (c), the normal vectors of the deflectors 851-852 lie on different planes, and hence the polarization of radiation 8FR (e.g., horizontally-polarized) and the polarization of radiation 8FR′ (e.g., vertically-polarized) are different. Specifically, because polarization is defined according to the incident surface, when the radiation 8FR, which is s-polarized with respect to the deflector 851, strikes the deflector 852 (oriented face-up at 45 degrees in FIG. 9 (b)), the reflected radiation 8FR′ becomes p-polarized with respect to the deflector 852. In other words, if the deflectors 851-852 are angled to direct the radiation 8FR′ perpendicular to the radiation 8FR, the polarization is changed. Next, the radiation 8FR′ reflects off the deflector 854, which directs the radiation 8FR″ to the deflector 855. Eventually, the deflector 853 directs the radiation 8FR′ outwards.

The polarization switcher 850 brings higher throughput since the reflectivity of a mirror in UV band may be higher than the transmission of a half-wave plate at UV frequencies.

The polarization switcher 850 causes no bandwidth problems because the polarization change of the radiation 8FR is not induced by the index of refraction. Its independence from the index of refraction also offers a higher extinction ratio across a broad bandwidth (e.g., more than 0.2 nanometers).

By using reflective optics instead of half-wave plates to alter polarization, the switcher 850 enhances durability. Although the radiation 8FR may carry high photon energy, mirrors typically have longer lifetime than half-wave plates, thereby extending the lifetime of the polarization switcher 850.

In addition to channel switching, the recipe controller 170 shown in FIG. 1 or 10 may control the polarization switcher(s) (e.g., 150P1 ... or 850) to determine/change polarization. Accordingly, the optical properties (e.g., wavelength or polarization) of the overall output radiation PR can be adjusted for applications at most efficient stage(s), optimizing performance for each specific use case.

FIG. 10 is a schematic diagram of a device 11, which may be implemented using the device 10, according to an embodiment of the present invention.

As set forth above, the recipe controller 170 may select at least one channel (e.g., CH1′ and CH2′) from the channels CH1′-CHn′ to determine the final spectrum of the output radiation PR.

In response to an instruction of the recipe controller 170, a nonlinear area 1060C of the device 11 may switch between different non-solid mediums (e.g., 160G1-160G2) to realize the nonlinear areas 160C1 ... or 160Cn. In other words, the combination of the channels CH1′-CHn′ and the nonlinear area 1060C corresponds to the channels CH1-CHn shown in FIG. 1.

In response to an instruction of the recipe controller 170, a wavelength separator 1080S of the device 11 may be adjusted to extract the desired frequencies. The wavelength separator 1080S may represent a collection of the wavelength separators 180S1-180Sn shown in FIG. 1. The wavelength separator 1080S may switch between the wavelength separators 180S1-180Sn to allow the desired frequencies to pass through.

When it comes to wafers with multi-layered structures, inspection using XUV light is highly sensitive to both thickness and material. Any variation in materials or thicknesses under XUV light can result in different inspection qualities (e.g., resolution). To inspect a wafer with a multi-layered structure, the present invention offers various spectrums, which may be narrow-band and customizable. These customizable spectrums of narrow-range frequencies together constitute a broad, continuous/discontinues spectrum of frequencies. An (optical) inspection device capable of adaptively producing XUV light of customizable spectrums is ideal for performing inspection of optical wafer defects. To sum up, compared to low conversion efficiency of HHG, DDP, or LSP, the present invention generates high power (more than 50 mW) and high brightness (more than 200 W/nm/srad/mm²) XUV radiation using cascade wavelength converting with optimal conversion efficiency at each stage/medium. The shorter wavelength (less than 193 nanometers) enables high resolution for small features detection. By optimizing the output power of wavelength conversion, an optical inspection can achieve the best signal-to-noise ratio (SNR).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radiation generator, comprising:
a radiation source, configured to provide input radiation;
at least one solid medium, optically coupled to the radiation source, and configured to convert the input radiation at least into first radiation via at least one first nonlinear process, wherein a first frequency of the first radiation is higher than an input frequency of the input radiation; and
a non-solid medium, optically coupled to the at least one solid medium, and configured to convert the first radiation at least into second radiation via a second nonlinear process, wherein a second frequency of the second radiation is higher than the first frequency;
wherein one of the at least first nonlinear process is a sum frequency generation process, a second harmonic generation process, or a third harmonic generation process;
wherein the second nonlinear process is a third harmonic generation process.

2. The radiation generator of claim 1,
wherein the second radiation is extreme ultraviolet radiation;
wherein the second radiation comprises a plurality of frequency components;
wherein each frequency component has an annular cross-section.

3. The radiation generator of claim 1, wherein one of the at least first nonlinear process is different from the second nonlinear process or another of the at least first nonlinear process.

4. The radiation generator of claim 1,
wherein the radiation generator is classified at least into a nonlinear area and a low absorption area;
wherein the non-solid medium substantially resides in the nonlinear area;
wherein the low absorption area substantially tapers to an outlet leading into the nonlinear area.

5. The radiation generator of claim 1, further comprising:
at least one first wavelength separator, configured to remove third radiation, at least having the input frequency, or extract the first radiation, wherein each of the at least one wavelength separator is optically coupled to one of the at least one solid medium; and
a second wavelength separator, optically coupled to the non-solid medium, and configured to remove fourth radiation, at least having the first frequency, or extract the second radiation;
wherein a first structure of one of the at least one first wavelength separator differs from a second structure of the second wavelength separator.

6. The radiation generator of claim 1, further comprising:
a second wavelength separator, optically coupled to the non-solid medium, and configured to remove fourth radiation, at least having the first frequency, or extract the second radiation, wherein the second wavelength separator comprises:
at least three dichroic mirrors, each comprising a surface, wherein one of the three surfaces is concave, convex, or flat, wherein an incident angle of the second radiation on one of the three surfaces is substantially larger than 60 degrees; or
a spatial filter, configured to extract the second radiation according to a fourth spatial distribution of the fourth radiation different from a second spatial distribution of the second radiation, wherein the second radiation has an annular cross-section, wherein the spatial filter is positioned to substantially overlap a cross-section of the fourth radiation.

7. The radiation generator of claim 1, further comprising:
a polarization switcher, optically coupled to the at least one solid medium, and configured to decide a polarization of the first radiation or the input radiation, wherein the polarization switcher comprises:
a switchable half-wave plate set, comprising a plurality of half-wave plates, and configured to switch between the half-wave plates to change the polarization of the first radiation or the input radiation; or
a path-dominating switcher, comprising:
a periscope, rotatable to change the polarization of the first radiation or the input radiation; and
at least one deflector, optically coupled to the periscope, and configure to change a path of the first radiation or the input radiation.

8. The radiation generator of claim 1, further comprising:
a spectrum shaper, configured to adjust a bandwidth or a central wavelength of the input radiation, wherein the spectrum shaper comprises a spectral broadening device, a spectral shifting device, a bandpass filter, a grating, or a slit.

9. The radiation generator of claim 1, further comprising:
a recipe controller, optically coupled to the non-solid medium, configured to control pressure, kind, or ratio of the non-solid medium, wherein the non-solid medium comprises at least one kind of non-solid substance.

10. A radiation generation method, comprising:
emitting the input radiation from the radiation source of the radiation generator of claim 1;
exciting the at least one solid medium, such that the input radiation is converted into at least into the first radiation via the at least one first nonlinear process; and
exciting the non-solid medium, such that the first radiation is converted into at least into the second radiation via the second nonlinear process.

11. An inspection device, for inspecting an object patterned by a lithographic process, comprising:
a radiation source, configured to provide input radiation;
at least one channel, optically coupled to the radiation source, wherein each of the at least one channel comprises:
at least one medium, configured to frequency-convert the input radiation; and
a recipe controller, optically coupled to the at least one channel, and configured to select one from the at least one channel according to characteristics of the object, such that the select channel is configured to convert the input radiation to second radiation.

12. The inspection device of claim 11, wherein the at least one medium comprises:
at least one solid medium, configured to convert the input radiation at least into first radiation via at least one first nonlinear process, wherein a first frequency of the first radiation is higher than an input frequency of the input radiation; and
a non-solid medium, optically coupled to the at least one solid medium, and configured to convert the first radiation at least into the second radiation via a second nonlinear process, wherein a second frequency of the second radiation is higher than the first frequency;
wherein one of the at least first nonlinear process is a sum frequency generation process, a second harmonic generation process, or a third harmonic generation process;
wherein the second nonlinear process is a third harmonic generation process.

13. The inspection device of claim 12, wherein one of the at least first nonlinear process is different from the second nonlinear process or another of the at least first nonlinear process.

14. The inspection device of claim 11,
wherein the second radiation is extreme ultraviolet radiation;
wherein the second radiation comprises a plurality of frequency components;
wherein each frequency component has an annular cross-section.

15. The inspection device of claim 11,
wherein the inspection device is classified at least into a nonlinear area and a low absorption area;
wherein a non-solid medium substantially resides in the nonlinear area;
wherein the low absorption area substantially tapers to an outlet leading into the nonlinear area.

16. The inspection device of claim 11, wherein each of the at least one channel further comprises:
at least one first wavelength separator, configured to remove third radiation at least having the input frequency or extract the first radiation, wherein each of the at least one wavelength separator is optically coupled to one solid medium; and
a second wavelength separator, optically coupled to a non-solid medium, and configured to remove fourth radiation at least having the first frequency or extract the second radiation;
wherein a first structure of one of the at least one first wavelength separator differs from a second structure of the second wavelength separator.

17. The inspection device of claim 11, wherein each of the at least one channel further comprises:
a second wavelength separator, optically coupled to the at least one medium, and configured to remove fourth radiation or extract the second radiation, wherein the second wavelength separator comprises:
at least three dichroic mirrors, each comprising a surface, wherein one of the three surfaces is concave, convex, or flat, wherein an incident angle of the second radiation on one of the three surfaces is substantially larger than 60 degrees; or
a spatial filter, configured to extract the second radiation according to a fourth spatial distribution of the fourth radiation different from a second spatial distribution of the second radiation, wherein the second radiation has an annular cross-section, wherein the spatial filter is positioned to substantially overlap a cross-section of the fourth radiation.

18. The inspection device of claim 11, wherein each of the at least one channel further comprises:
a polarization switcher, optically coupled to the at least one medium, and configured to decide a polarization of first radiation or the input radiation, wherein the polarization switcher comprises:
a switchable half-wave plate set, comprising a plurality of half-wave plates, and configured to switch between the half-wave plates to change the polarization of the first radiation or the input radiation; or
a path-dominating switcher, comprising:
a periscope, rotatable to change the polarization of the first radiation or the input radiation; and
at least one deflector, optically coupled to the periscope, and configure to change a path of the first radiation or the input radiation.

19. The inspection device of claim 11, further comprising:
a spectrum shaper, configured to adjust a bandwidth or a central wavelength of the input radiation, wherein the spectrum shaper comprises a spectral broadening device, a spectral shifting device, a bandpass filter, a grating, or a slit.

20. A radiation generation method, for outputting second radiation of a target wavelength, comprising:
emitting input radiation from a radiation source;
adjusting, by a spectrum shaper, a wavelength of the input radiation according to the target wavelength; and
exciting at least one medium of one of at least one channel for frequency conversion;
wherein a recipe controller is configured to select one from the at least one channel, such that the select channel is configured to convert the input radiation adjusted into the second radiation of the target wavelength.
